(19) United States
(12) Patent Application Publication
(10) Pub. No.: US 2005/0057493 A1
(43) Pub. Date: Mar. 17, 2005

(54) Thumb stylus

(76) Inventor: Ross Chun, Aliso Viejo, CA (US)

Correspondence Address: Ross Chun, 27 Sequoia Dr., Aliso Viejo, CA, 92656, US

(21) Appl. No.: 10/661,076

(22) Filed: Sep. 15, 2003

(51) Int. Cl. G09G 5/00

(52) U.S. Cl. 345/156

(57) ABSTRACT

Thumb Stylus is used as a navigation tool for Personal Digital Assistants (PDA's) that employ a touch-screen interface. PDA's allow access to files and various functions through drop down menus and navigation buttons. The Thumb Stylus is slipped onto the tip of the end-user's thumb, providing a more accurate interface point to select menus, individual menu items and navigation points and most importantly, single-handed use of the PDA. The fine point of the implement allows for accurate selection of menus, individual menu items and navigation points within the PDA interface without damaging the touch-screen surface.

### BACKGROUND OF THE INVENTION

This implement was designed and developed for use with such data devices as Personal Digital Assistants (PDAs), electronic calendars, Smart Phones and other hand-held Palm® and Windows® based devices that employ a touch screen interface and/or mechanical button interface. The Thumb Stylus allows for the accurate selection of menus and individual menu items within the touch screen interface.

The PDA and other electronic data devises described hereto, generally include a pen-like stylus that requires 2 hands to operate the device and select menu items. The end-user holds the actual electronic data device in one had, and navigates through the interface with the pen-type stylus held in the other hand. With the Thumb Stylus, the end-user can hold the electronic data device in one hand, and navigate through the touch screen or mechanical button interface using the Thumb Stylus worn on the thumb of the same hand, thus utilizing the device with only one hand, instead of two.

It is therefore a general object of the present invention to provide an implement that allows the end-user to operate the electronic data device, PDA, Smart Phone, etc. with one hand, freeing up the other had for other uses.

Another object of the invention is to provide a stylus implement small enough to be carried in the end-user's pocket, handbag, or brief case without taking up noticeable space or damaging other items also contained therein.

Still another object of the invention is to allow the end-user to wear the Thumb Stylus comfortably while working with other business devices and changing tasks back and forth. The end-user can change to manual writing with a pen, dial a wireless phone, etc., and return to the use of the Thumb Stylus and the electronic data device.

### DESCRIPTION OF THE FIGURE(S) OF THE DRAWING

FIG. 1 shows the left profile elevation of the Thumb Stylus, with the downward curved surface of the stylus point on the bottom of the implement. (01 represents the indicator point of the Thumb Stylus, used to isolate and access individual menu items and navigation destinations within the PDA interface.)

FIG. 2 shows the top view of the Thumb Stylus. The bottom portion of the implement is defined by the asymmetrical curve of the stylus point, partially obscured by the curvature of top band. (01 represents the indicator point of the Thumb Stylus, used to isolate and access individual menu items and navigation destinations within the PDA interface.)

FIG. 3 shows the right profile elevation of the Thumb Stylus, with the downward curve of the stylus point depicted on the right side of the illustration. (02 represents the open-ended design that allows for a comfortable, secure fit that adjusts to most thumb sizes.)

FIG. 4 shows the top view of the Thumb Stylus as worn on the end-user's right thumb. The bottom portion of the implement is defined by the asymmetrical curve of the stylus indicator point. It is partially obscured by the curvature of the top band and the representation of the end-user's thumb. (01 represents the indicator point of the Thumb Stylus, used to isolate and access individual menu items and navigation destinations within the PDA interface.)

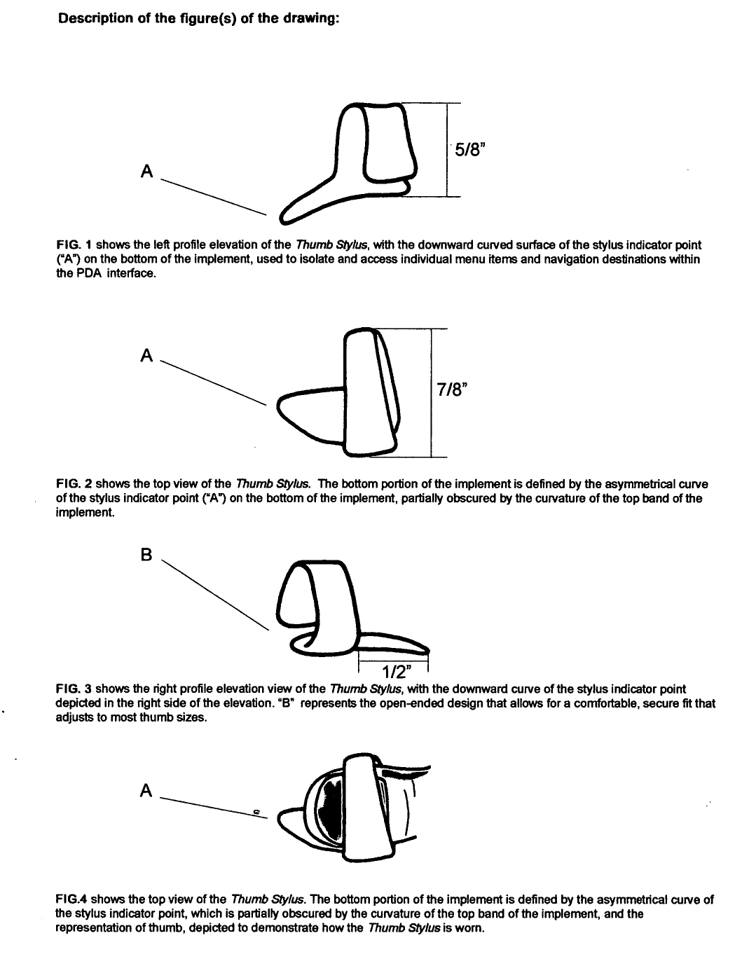

1. The Thumb Stylus for use with touch-screen interface PDA's, is constructed of a single piece of injection molded plastic, flexible, with a tapered tip that allows for accurate selection of menus and menu items within the PDA's interface.

2. Said Thumb Stylus described in claim 1 has an asymmetrical, tapered body that partially wraps around the end-user's thumb, leaving an open gap that allows for easy application and removal.

3. The flexibility of the plastic that comprises the Thumb Stylus described in claim 1, gives slightly to accommodate a variety of thumb sizes with a firm, stable fit.

4. Said Thumb Stylus described in claim 1 is composed of an injection molded plastic that will flex when making contact with the PDA screen with firm but minimal pressure, and will not damage or scratch the screen of the PDA device.

5. The tapered tip of the Thumb Stylus described in claim 1 curves away from the end-user's thumb tip, pointing away from the thumb nail and toward the PDA device screen allowing for more accurate selection of menus, menu items and navigation buttons depicted on the PDA screen.

6. Said Thumb Stylus described in claim 1 has a simple, elegant design that is light-weight and easy to carry in the end-user's pocket, briefcase or handbag.
